(19) United States
(12) Patent Application Publication
(10) Pub. No.: US 2024/0357284 A1
(43) Pub. Date: Oct. 24, 2024

(54) MICROPHONE DIRECTIONAL BEAMFORMING ADJUSTMENTS

(71) Applicant: Hewlett-Packard Development Company, L.P., Spring, TX (US)

(72) Inventors: CHUNG-CHUN CHEN, Taipei City (TW); MING-SHIEN TSAI, Taipei City (TW); CHIH-MING HUANG, Taipei City (TW)

(73) Assignee: Hewlett-Packard Development Company, L.P., Spring, TX (US)

(21) Appl. No.: 18/560,766

(22) PCT Filed: Jun. 7, 2021
(86) PCT No.: PCT/US2021/036124

§ 371 Date: Nov. 14, 2023

(51) Int. Cl. H04R 3/00; G06F 3/0354; H04R 1/02; H04R 1/32

(52) U.S. Cl. CPC H04R 3/00; G06F 3/03545; H04R 1/028; H04R 1/326; H04R 2499/15

(57) ABSTRACT

Example implementations relate to microphone directional beamforming adjustments. In some examples, a computing device can include a microphone, a wireless receiver, and a processor, where the processor is to receive a wireless signal from a peripheral device, determine a location of the peripheral device based on a signal strength between the peripheral device and the wireless receiver, and cause, based on the location of the peripheral device, the microphone to adjust a beamforming direction of the microphone.

### BACKGROUND

Some users of computing devices may utilize their computing devices in different environments. Certain computing devices can be portable to allow a user to carry or otherwise bring with the computing device in different settings. A computing device can allow a user to utilize computing device operations for work, education, gaming, multimedia, and/or other general use in such different settings.

### BRIEF DESCRIPTION OF THE DRAWINGS

FIG. 1 illustrates an example of a computing device including a microphone for microphone directional beamforming adjustments consistent with the disclosure.

FIG. 2 illustrates an example of a computing device including microphones and an example of a peripheral device in various locations for microphone directional beamforming adjustments consistent with the disclosure.

FIG. 3 illustrates an example of a method for microphone directional beamforming adjustments consistent with the disclosure.

FIG. 4 illustrates a block diagram of an example system for microphone directional beamforming adjustments consistent with the disclosure.

### DETAILED DESCRIPTION

A user may utilize a computing device for various purposes, such as for business and/or recreational use. As used herein, the term “computing device” refers to an electronic system having a processing resource, memory resource, and/or an application-specific integrated circuit (ASIC) that can process information. A computing device can be, for example, a laptop computer, a notebook, a desktop, a tablet, and/or a mobile device, among other types of computing devices.

During a virtual meeting (e.g., conducted via a user's computing device), the user may speak and such audio produced by the user can be received by a microphone included in the computing device. As used herein, the term “virtual meeting” refers to a conference extended by computing device software in which the reception and transmission of audio signals, video signals, or combinations thereof occurs between users in different locations. For example, multiple users may conduct a virtual meeting in which the first user can communicate, through the first user's computing device, with the second user through the second user's computing device and vice versa via transmission of audio signals, video signals, or combinations thereof therebetween. As used herein, the term “microphone” refers to a device that converts sound into an electrical signal. While conducting a virtual meeting, the first user may audibly speak and a microphone can convert such audible speech into an electrical signal for transmission to the second user so that the second user can hear what the first user is saying.

During such virtual meetings, the first user may walk about a space in which the user's computing device is located, such as an office, conference room, or other space. While the microphone in the first user's computing device may clearly receive audible speech from the first user in one location, when the first user moves to a second location, the microphone may not clearly receive the audible speech. This may be the result of the beamforming direction of the microphone, as is further described herein. Further, in the event that another user (e.g., a third user) is in the same space as the first user, the third user may mute their computing device in order to prevent audio feedback.

Some microphones may have an associated beamforming direction. As used herein, the term “beamforming” refers to a direction of a sensor for directional signal reception. For example, a microphone of a computing device may have an associated direction in which it is pointed for reception of audible noise.

In an example in which the user is in a particular location in a space, such beamforming directions of certain microphones may not be able to clearly receive audible speech from the user because the beamforming direction of the microphone is not directed at the location of the user. Further, such beamforming directions of certain microphones may be fixed when the computing device is manufactured. As a result, the audible speech from the user may not be clearly received by the microphone, resulting in other virtual meeting attendees not clearly hearing what the user is saying when the user is in such a location within a space.

Microphone directional beamforming adjustments can allow for a microphone of a computing device to adjust its beamforming direction. The beamforming direction can be adjusted based on a location of a peripheral device in wireless communication with the computing device. Adjusting the beamforming direction of a microphone can allow for audible speech from a user to be clearly received by a microphone no matter the location of the user in a space, allowing for clearer audio transmission as compared with previous approaches.

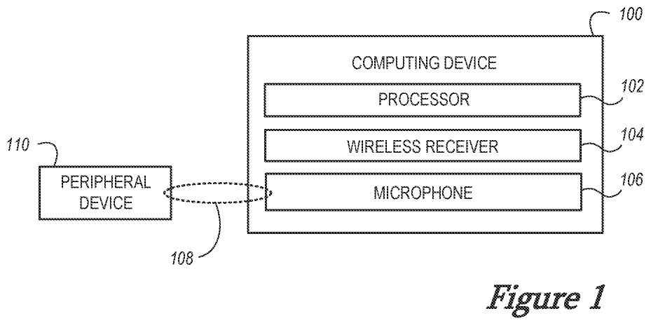

FIG. 1 illustrates an example of a computing device 100 including a microphone 106 for microphone directional beamforming adjustments consistent with the disclosure. As illustrated in FIG. 1, the computing device 100 can include a processor 102, a wireless receiver 104, and the microphone 106.

As mentioned above, a beamforming direction 108 of the microphone 106 can be adjusted based on a location of a peripheral device 110. As used herein, the term “peripheral device” refers to an auxiliary device to transit information to and/or receive information from a computing device. The peripheral device 110 can, in some examples, be a stylus. For example, a user of the computing device 100 may be conducting a virtual meeting utilizing the computing device 100 and can utilize the peripheral device 110 (e.g., the stylus) to input information to the computing device 100, such as advancing a slide of a slide presentation.

Although the peripheral device 110 is described above as being a stylus, examples of the disclosure are not so limited. For example, the peripheral device 110 can be a mouse, a pen, a mobile device, etc.

The peripheral device 110 can be in wireless communication with the computing device 100 via the wireless receiver 104. As used herein, the term “wireless receiver” refers to an electronic device that receives radio waves and converts the information carried in the radio waves into a signal for processing. Such wireless communication can be a network relationship. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WIMAX), Near Field Communication (NFC), infrared (IR) communication, Public Switched Telephone Network (PSTN), radio waves, and/or the Internet, among other types of network relationships. For example, the peripheral device 110 can be in wireless communication with the wireless receiver 104 of the computing device 100 via a Bluetooth connection.

As a result of the wireless connection between the peripheral device 110 and the wireless receiver 104, the peripheral device 110 can transmit a wireless signal to the wireless receiver 104. As such, the processor 102 can receive the wireless signal from the peripheral device 110 via the wireless receiver 104. In some examples, the wireless signal is a keepalive packet. As used herein, the term “keepalive packet” refers to a message sent from one device to another device to check a link between the two devices is active and/or to prevent the link from being broken. For example, the peripheral device 110 can transmit keepalive packets periodically to the wireless receiver 104 to keep the wireless connection therebetween from being broken, to check the link between the peripheral device 110 and the wireless receiver 104, or combinations thereof.

The processor 102 can determine a location of the peripheral device 110 based on a signal strength between the peripheral device 110 and the wireless receiver 104. The signal strength can be a received signal strength indicator (RSSI) associated with the keepalive packet. As used herein, the term “RSSI” refers to a measurement of power present in a received radio signal. For example, the peripheral device 110 can transmit a keepalive packet to the wireless receiver 104 having an associated RSSI value. The processor 102 can determine the RSSI value associated with the keepalive packet to be, for instance, −55 decibel-milliwatts (dBm).

Utilizing the RSSI value, the processor 102 can determine the location of the peripheral device 110 based on the RSSI value (e.g., the signal strength) between the peripheral device 110 and the wireless receiver 104. The processor 102 can determine the location of the peripheral device 110 in response to the RSSI value exceeding a threshold amount. In some examples, the threshold amount may be, for instance, −45 dBm. In response to the RSSI value of the keepalive packet exceeding the threshold amount (e.g., −55 dBm), the processor 102 can determine the peripheral device 110 is located at a direction “left” of the computing device 100 (e.g., as oriented in FIG. 1). As a user of the computing device 100 may be utilizing the peripheral device 110 during the virtual meeting, the beamforming direction 108 of the microphone 106 can be adjusted towards the peripheral device 110, as is further described herein.

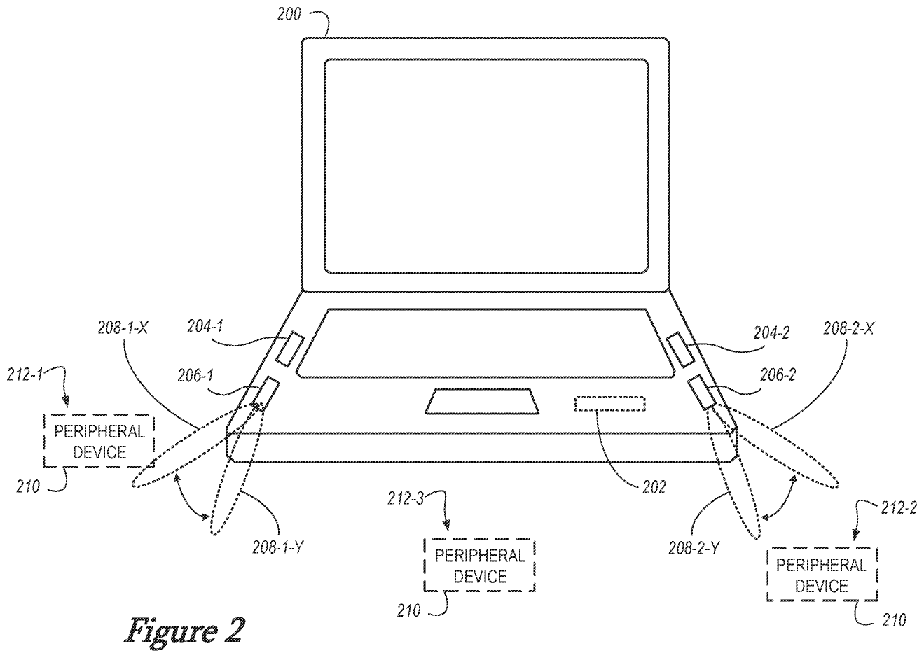

As the peripheral device 110 is determined to be in a direction “left” of the computing device 100, the processor 102 can cause the microphone 106 to adjust the beamforming direction 108 of the microphone. The processor 102 can adjust the beamforming direction 108 of the microphone towards the location of the peripheral device 110 for reception of audible noise, as is further described in connection with FIG. 2.

FIG. 2 illustrates an example of a computing device 200 including microphones 206-1, 206-2 and an example of a peripheral device 210 in various locations 212 for microphone directional beamforming adjustments consistent with the disclosure. As illustrated in FIG. 2, the computing device 200 can include a processor 202, first wireless receiver 204-1, second wireless receiver 204-2 (referred to herein collectively as wireless receivers 204), first microphone 206-1, and second microphone 206-2 (referred to herein collectively as microphones 206).

As previously mentioned, a user of the computing device 200 may conduct a virtual meeting using the computing device 200. The processor 202 can cause beamforming direction adjustment of one or all of the microphones 206 during a virtual meeting, as is further described herein.

The processor 202 can determine whether a virtual meeting has been initiated by the computing device 200. For example, the processor 202 can determine when the virtual meeting has been initiated by determining a virtual meeting application program has been launched, determining whether a user has joined/connected to a scheduled virtual meeting within the virtual meeting application program, determining whether communication has occurred within the scheduled virtual meeting program (e.g., detection of text/chat input, detection of video, detection of audio exchange, etc.), or combinations thereof.

In response to the virtual meeting being initiated, the processor 202 can cause the wireless receivers 204 to monitor for a wireless signal from the peripheral device 210 and for motion data from the peripheral device 210. As illustrated in FIG. 2, the peripheral device 210 can be in different locations 212 relative to the computing device 200. For example, the peripheral device 210 can be in a first location 212-1 (e.g., located to the “left” of the computing device 200), in a second location 212-2 (e.g., located to the “right” of the computing device 200), or in a third location 212-3 (e.g., located in “front” of the computing device 200). However, the peripheral device 210 may be located in any other location.

As previously described in connection with FIG. 1, the wireless signal can include an RSSI value. For instance, the peripheral device 210 can include a first RSSI value with the first wireless receiver 204-1 and a second RSSI value with the second wireless receiver 204-2. Such RSSI values with the wireless receivers 204 can depend on the location 212 of the peripheral device 210. For example, when the peripheral device 210 is in the first location 212-1, the first RSSI value between the peripheral device 210 and the first wireless receiver 204-1 may be higher than the second RSSI value between the peripheral device 210 and the second wireless receiver 204-1 since the peripheral device 210 is physically closer to the first wireless receiver 204-1 than the second wireless receiver 204-2. However, when the peripheral device 210 is in the second location 212-2, the first RSSI value between the peripheral device 210 and the first wireless receiver 204-1 may be lower than the second RSSI value between the peripheral device 210 and the second wireless receiver 204-1 since the peripheral device 210 is physically closer to the second wireless receiver 204-2 than the first wireless receiver 204-1.

As mentioned above, the processor 202 can also monitor for motion data from the peripheral device 210. As used herein, the term “motion data” refers to data describing motion of an object. Although not illustrated in FIG. 2, the peripheral device 210 can include a sensor. As used herein, the term “sensor” refers to a device to detect events and/or changes in its environment and transmit the detected events and/or changes for processing and/or analysis. In some examples, the peripheral device 210 can include an accelerometer, gyroscopic sensor, or combinations thereof, among other types of sensors. The accelerometer can measure linear motion (e.g., velocity, acceleration, etc.) of the peripheral device, the gyroscopic sensor can measure orientation, angular velocity, etc. (e.g., tilt, lateral orientation, etc.) of the peripheral device, or combinations thereof. Such motion data can be transmitted to the processor 202 via the wireless receivers 204.

In response to receiving the motion data, the processor 202 can determine the location 212 of the peripheral device 210. Using the motion data when received from the peripheral device 210 to begin the location determination of the peripheral device 210 can allow for power savings by the computing device 200, as when the peripheral device 210 is stationary, there may not be a desire to adjust the beamforming direction 208 of the microphones 206 (e.g., since the beamforming direction 208 should be set such that audible noise is clearly received from a user, etc.).

Accordingly, in response to receiving the motion data, the processor 202 can determine the peripheral device 210 to be in the first location 212-1, the second location 212-2, the third location 212-3, or any other location in a space in which the computing device 200 is located. Determination of the location 212 of the peripheral device 210 can be accomplished via the first RSSI value and the second RSSI value, as is further described herein. Based on the location 212 of the peripheral device 210, the processor 202 can cause the first microphone 206-1, the second microphone 206-2, or combinations thereof to adjust the beamforming direction 208-1, 208-2, respectively, as is further described herein.

In some examples, the processor 202 can determine the location 212 of the peripheral device 210 to be the first location 212-1. As previously described in connection with FIG. 1, if an RSSI value exceeds a threshold value (e.g., −55 dBm), the processor 202 can determine a particular location 212 of the peripheral device 210. The processor 202 can receive the wireless signal having a first RSSI value (e.g., −45 dBm) between the peripheral device 210 and the first wireless receiver 204-1 and a second RSSI value (e.g., −65 dBm) between the peripheral device 210 and the second wireless receiver 204-2. Since the first RSSI value of −45 dBm exceeds the threshold value of −55 dBm and the second RSSI value of −65 dBm does not exceed the threshold value of −55 dBm, the processor 202 can determine the peripheral device 210 is in the first location 212-1. As such, the processor 202 can cause the microphone 206-1 to adjust the beamforming direction 208-1 toward the first location 212-1. For example, the beamforming direction may be in direction 208-1-Y, and the processor 202 can cause the microphone 206-1 to adjust the beamforming direction from 208-1-Y to 208-1-X, which is in a direction towards the first location 212-1 of the peripheral device 210. Adjusting the beamforming direction of the first microphone 206-1 from beamforming direction 208-1-Y to beamforming direction 208-1-X can allow the first microphone 206-1 to more clearly receive audible speech from a user utilizing the peripheral device 210 in the virtual meeting as compared with beamforming direction 208-1-Y.

In some examples, the processor 202 can determine the location 212 of the peripheral device 210 to be the second location 212-2. Similar to the example above, the threshold RSSI value can be −55 dBm, and if an RSSI value exceeds a threshold value (e.g., −55 dBm), the processor 202 can determine a particular location 212 of the peripheral device 210. The processor 202 can receive the wireless signal having a first RSSI value (e.g., −65 dBm) between the peripheral device 210 and the first wireless receiver 204-1 and a second RSSI value (e.g., −45 dBm) between the peripheral device 210 and the second wireless receiver 204-2. Since the second RSSI value of −45 dBm exceeds the threshold value of −55 dBm and the first RSSI value of −65 dBm does not exceed the threshold value of −55 dBm, the processor 202 can determine the peripheral device 210 is in the second location 212-2. As such, the processor 202 can cause the microphone 206-2 to adjust the beamforming direction 208-2 toward the second location 212-2. For example, the beamforming direction may be in direction 208-2-X, and the processor 202 can cause the microphone 206-2 to adjust the beamforming direction from 208-2-X to 208-2-Y, which is in a direction towards the second location 212-2 of the peripheral device 210. Adjusting the beamforming direction of the second microphone 206-2 from beamforming direction 208-2-X to beamforming direction 208-2-Y can allow the second microphone 206-2 to more clearly receive audible speech from a user utilizing the peripheral device 210 in the virtual meeting as compared with beamforming direction 208-2-X.

In some examples, some examples, the processor 202 can determine the location 212 of the peripheral device 210 to be the third location 212-3. As previously described in connection with FIG. 1, if an RSSI value exceeds a threshold value (e.g., −55 dBm), the processor 202 can determine a particular location 212 of the peripheral device 210. The processor 202 can receive the wireless signal having a first RSSI value (e.g., −45 dBm) between the peripheral device 210 and the first wireless receiver 204-1 and a second RSSI value (e.g., −50 dBm) between the peripheral device 210 and the second wireless receiver 204-2. Since both the first RSSI value of −45 dBm and the second RSSI value of −50 exceed the threshold value of −55 dBm, the processor 202 can determine the peripheral device 210 is in the third location 212-3. As such, the processor 202 can cause the microphones 206-1 and 206-2 to adjust their beamforming directions 208-1 and 208-2 towards the third location 212-3. For example, the beamforming direction of the first microphone 206-1 may be in direction 208-1-X and the beamforming direction of the second microphone 206-2 may be in the direction 208-2-X. The processor 202 can cause the microphone 206-1 to adjust the beamforming direction from 208-1-X to 208-1-Y and can cause the microphone 206-2 to adjust the beamforming direction from 208-2-X to 208-2-Y, both in the direction towards the third location 212-3 of the peripheral device 210. Adjusting the beamforming direction of the first microphone 206-1 from beamforming direction 208-1-X to beamforming direction 208-1-Y and the second microphone 206-2 from beamforming direction 208-2-X to beamforming direction 208-2-Y can allow both the first microphone 206-1 and the second microphone 206-2 to more clearly receive audible speech from a user utilizing the peripheral device 210 in the virtual meeting as compared with beamforming directions 208-1-X and 208-2-X.

Although the computing device 200 is illustrated as including two wireless receivers 204-1, 204-2, and two microphones 206-1, 206-2, examples of the disclosure are not so limited. For example, the computing device 200 can include less than two wireless receivers and less than two microphones, or more than two wireless receivers and more than two microphones.

The processor 202 can adjust the beamforming directions 208 via a daemon. As used herein, the term “daemon” refers to a computer program that runs as a background process. For example, the processor 202 can cause the daemon to execute to cause the beamforming directions 208 to be adjusted.

When the peripheral device 210 stops sending motion data, the processor 202 can cease adjustment of the beamforming directions 208. In response to the processor 202 not receiving motion data from the peripheral device 210 within a threshold amount of time (e.g., 30 seconds), the processor 202 can cease adjustment of the beamforming directions 208 of the microphones 206. For example, a user may set down the peripheral device 210 in the first location 212-1 for 40 seconds or longer and emit audible noise from the first location 212-1. In response to the peripheral device 210 ceasing transmission of motion data (e.g., since the peripheral device 210 is stationary), the processor 202 can cease adjustment of the beamforming directions 208 of the microphones 206, which can save power for the computing device 200 since the user may be stationary in or proximately located at the first location 212-1 as well.

If the peripheral device 210 were moved from the first location 212-1 to the second location 212-2, a further wireless signal may be received by the wireless receivers 204. In response, the processor 202 can determine the new location of the peripheral device 210 to be the second location 212-2 based on a new signal strength (e.g., updated first RSSI value and updated second RSSI value) between the peripheral device 210 and the first wireless receiver 204-1 and the second wireless receiver 204-2, respectively. The processor 202 can cause the microphones 206 to update their beamforming directions 208 towards the new location of the peripheral device 210 accordingly, as described above.

In response to the virtual meeting ending, the processor 202 can cease adjustment of the beamforming directions 208 of the microphones 206. For example, once the virtual meeting has ended, a user may no longer be emitting audible noise for the microphones 206 to receive. The processor 202 can detect the virtual meeting has ended (e.g., as a result of the virtual meeting program being closed, the user leaving the scheduled virtual meeting, etc.). In response to such a detection, the processor 202 can cease adjustment of the beamforming directions 208 of the microphones 206.

As such, microphone directional beamforming adjustments can allow for beamforming directions of microphones to be adjusted based on a location of a peripheral device. Adjusting the beamforming directions of microphones towards the location of the peripheral device can allow for audible noise to be more clearly received by a microphone no matter the location of the peripheral device and/or the user within a space.

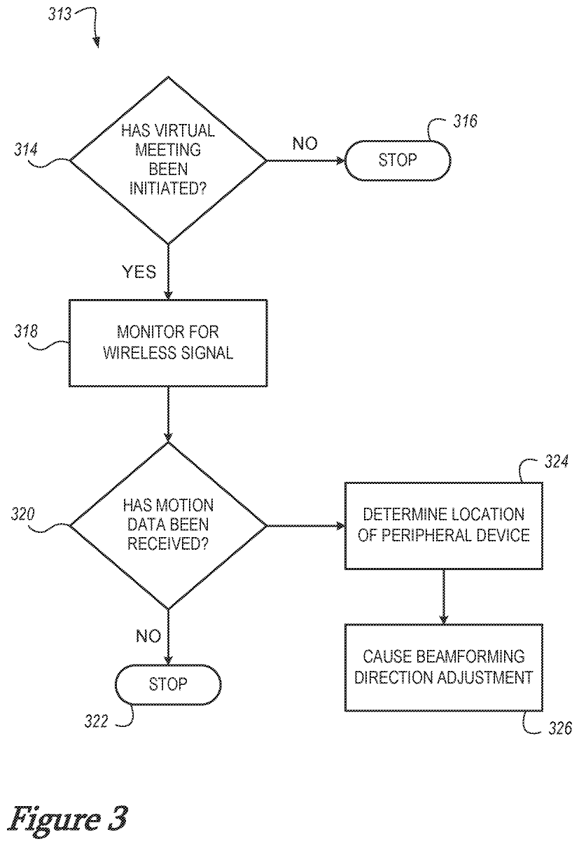

FIG. 3 illustrates an example of a method 313 for microphone directional beamforming adjustments consistent with the disclosure. The method 313 may be performed by, for instance, a processor of a computing device.

At 314, the method 313 can include determining, at 314, whether a virtual meeting has been initiated. For example, the processor can determine when the virtual meeting has been initiated by determining a virtual meeting application program has been launched, determining whether a user has joined/connected to a scheduled virtual meeting within the virtual meeting application program, determining whether communication has occurred within the scheduled virtual meeting program (e.g., detection of text/chat input, detection of video, detection of audio exchange, etc.), or combinations thereof.

In response to the virtual meeting not having been initiated, the method 313 can stop at 316. In response to the virtual meeting having been initiated, the processor can monitor for a wireless signal. The wireless signal can be a keepalive packet received from a peripheral device by a wireless receiver of the computing device and can include an RSSI value.

At 320, the method 313 can include determining whether motion data has been received from the peripheral device. Motion data can include data from an accelerometer, a gyroscope, or any other motion sensor to generate motion data describing motion of the peripheral device. The motion data can be included as part of the wireless signal received from the peripheral device by the wireless receiver of the computing device.

In response to motion data not having been received, the method 313 can stop at 322. In response to the motion data having been received, the processor of the computing device can determine, at 324, a location of the peripheral device. Additionally, the computing device can cause, at 326, a beamforming direction adjustment of a microphone of the computing device towards the location of the peripheral device.

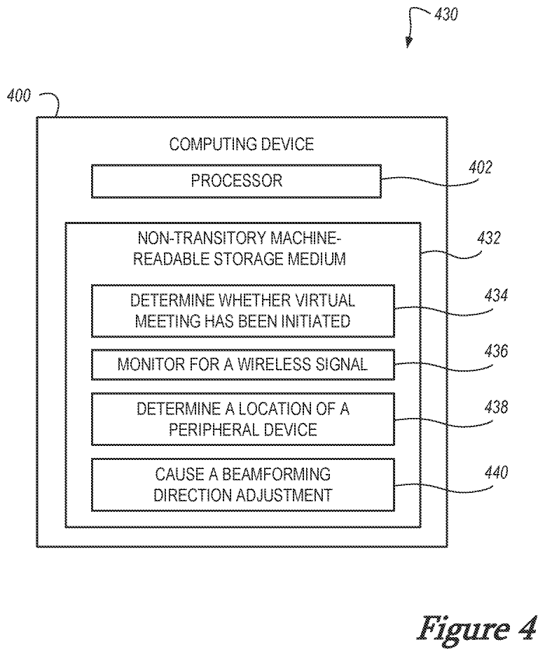

FIG. 4 illustrates a block diagram of an example system 430 for microphone directional beamforming adjustments consistent with the disclosure. In the example of FIG. 4, system 430 includes a processor 402 and a non-transitory machine-readable storage medium 432. The processor 402 can be a processing resource. The following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

The processor 402 may be a central processing unit (CPU), microprocessor, and/or other hardware device suitable for retrieval and execution of instructions stored in a non-transitory machine-readable storage medium 432. In the particular example shown in FIG. 4, the processor 402 may receive, determine, and send instructions 434, 436, 438, and 440. As an alternative or in addition to retrieving and executing instructions, the processor 402 may include an electronic circuit comprising a number of electronic components for performing the operations of the instructions in the non-transitory machine-readable storage medium 432. With respect to the executable instruction representations or boxes described and shown herein, it should be understood that part or all of the executable instructions and/or electronic circuits included within one box may be included in a different box shown in the figures or in a different box not shown.

The non-transitory machine-readable storage medium 432 may be any electronic, magnetic, optical, or other physical storage device that stores executable instructions. Thus, the non-transitory machine-readable storage medium 432 may be, for example, Random Access Memory (RAM), an Electrically-Erasable Programmable Read-Only Memory (EEPROM), a storage drive, an optical disc, and the like. The executable instructions may be “installed” on the system 430 illustrated in FIG. 4. The non-transitory machine-readable storage medium 432 may be a portable, external or remote storage medium, for example, that allows the system 430 to download the instructions from the portable/external/remote storage medium. In this situation, the executable instructions may be part of an “installation package”.

Determine instructions 434, when executed by the processor 402, may cause system 430 to determine whether a virtual meeting has been initiated by the computing device 400. The virtual meeting can be a conference in which transmission and reception of audio signals, video signals, or combinations thereof, may be communicated between attendees (e.g., users) of the virtual meeting.

Monitor instructions 436, when executed by the processor 402, may cause system 430 to monitor for a wireless signal from a peripheral device. The computing device 400 may further include a wireless receiver that can monitor for the wireless signal in response to the virtual meeting being initiated.

Determine instructions 438, when executed by the processor 402, may cause system 430 to determine, in response to the wireless signal being received, a location of the peripheral device relative to the computing device 400 based on a signal strength between the peripheral device and the wireless receiver. The signal strength may be associated with the wireless signal received by the wireless receiver from the peripheral device.

Cause instructions 440, when executed by the processor 402, may cause system 430 to cause, based on the determined location of the peripheral device, a microphone to adjust a beamforming direction of a microphone of the computing device 400 towards the location of the peripheral device. Adjustment of the beamforming direction of the microphone towards the location of the peripheral device can allow for more clear reception of audible noise emitted proximate to the location of the peripheral device as compared with the beamforming direction of the microphone prior to adjustment.

In the foregoing detailed description of the disclosure, reference is made to the accompanying drawings that form a part hereof, and in which is shown by way of illustration how examples of the disclosure may be practiced. These examples are described in detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, “a plurality of” an element and/or feature can refer to more than one of such elements and/or features.

What is claimed is:

1. A computing device, comprising:
a microphone;
a wireless receiver; and
a processor, wherein the processor is to:
receive a wireless signal from a peripheral device:
determine a location of the peripheral device based on a signal strength between the peripheral device and the wireless receiver; and
cause, based on the location of the peripheral device, the microphone to adjust a beamforming direction of the microphone.

2. The computing device of claim 1, wherein the processor is to adjust the beamforming direction towards the location of the peripheral device, wherein the peripheral device is a stylus.

3. The computing device of claim 1, wherein the wireless signal is a keepalive packet.

4. The computing device of claim 3, wherein the signal strength is a received signal strength indicator (RSSI) associated with the keepalive packet.

5. The computing device of claim 4, wherein the processor is to determine the location of the peripheral device in response to the RSSI exceeding a threshold amount.

6. The computing device of claim 1, wherein the processor is to adjust the beamforming direction via a daemon.

7. A non-transitory machine-readable storage medium including instructions that when executed cause a processor of a computing device to:
determine whether a virtual meeting has been initiated by the computing device;
monitor, by a wireless receiver of the computing device in response to the virtual meeting being initiated, for a wireless signal from a peripheral device;
determine, in response to the wireless signal being received, a location of the peripheral device relative to the computing device based on a signal strength between the peripheral device and the wireless receiver; and
cause, based on the location of the peripheral device, a microphone to adjust a beamforming direction of the microphone towards the location of the peripheral device.

8. The non-transitory storage medium of claim 7, including instructions to determine, in response to a further wireless signal being received, a new location of the peripheral device based on a new signal strength between the peripheral device and the wireless receiver.

9. The non-transitory storage medium of claim 8, including instructions to cause the microphone to update the beamforming direction towards the new location of the peripheral device.

10. The non-transitory storage medium of claim 7, including instructions to cease, in response to the virtual meeting ending, adjustment of the beamforming direction of the microphone.

11. A computing device, comprising:
a microphone;
a first wireless receiver and a second wireless receiver; and
a processor, wherein the processor is to:
determine whether a virtual meeting has been initiated by the computing device;
monitor, by the first wireless receiver and the second wireless receiver in response to the virtual meeting being initiated, for a wireless signal from a peripheral device, wherein the wireless signal includes a first received signal strength indicator (RSSI) value with the first wireless receiver, a second RSSI value with the second wireless receiver, and motion data from the peripheral device;
determine, in response to receiving the motion data, a location of the peripheral device based on the first RSSI value and the second RSSI value; and
cause, based on the location of the peripheral device, the microphone to adjust a beamforming direction of the microphone.

12. The computing device of claim 11, wherein the processor is to:
determine the location to be a first location in response to the first RSSI value exceeding a threshold value and the second RSSI value not exceeding the threshold value; and
cause the microphone to adjust the beamforming direction toward the first location.

13. The computing device of claim 12, wherein the processor is to:
determine the location to be a second location in response to the first RSSI value not exceeding the threshold value and the second RSSI value exceeding the threshold value; and
cause the microphone to adjust the beamforming direction toward the second location.

14. The computing device of claim 11, wherein the processor is to:
determine the location in response to the first RSSI value exceeding a threshold value and the second RSSI value exceeding the threshold value; and
cause the microphone to adjust the beamforming direction toward the location.

15. The computing device of claim 11, wherein the processor is to cease, in response to not receiving the motion data from the peripheral device within a threshold amount of time, adjustment of the beamforming direction of the microphone.
